(19) United States
(12) Patent Application Publication
(10) Pub. No.: US 2017/0078644 A1
(43) Pub. Date: Mar. 16, 2017

(54) CONTROLLER APPLIED TO A THREE-DIMENSIONAL (3D) CAPTURE DEVICE AND 3D IMAGE CAPTURE DEVICE

(71) Applicant: eYs3D Microelectronics, Co., Taipei City (TW)

(72) Inventor: Yung-Wei Chen, Taipei City (TW)

(21) Appl. No.: 15/260,329

(22) Filed: Sep. 9, 2016

Related U.S. Application Data
(60) Provisional application No. 62/217,027, filed on Sep. 11, 2015.

(51) Int. Cl. H04N 13/02

(52) U.S. Cl. CPC H04N 13/0239; H04N 13/0271; H04N 13/0253

(57) ABSTRACT

A controller applied to a three-dimensional (3D) capture device includes an input circuit, an object distance generator, and an output circuit. The input circuit is used for receiving at least two images, wherein the at least two images are used for synthesizing a 3D image. The object distance generator is coupled to the input circuit for generating a distance between at least one object included in the 3D image and the 3D image capture device according to the at least two images. The output circuit is coupled to the object distance generator for outputting the distance between the at least one object and the 3D image capture device to a host.

### CROSS REFERENCE TO RELATED APPLICATIONS

This application claims the benefit of U.S. Provisional Application No. 62/217,027, filed on Sep. 11, 2015 and entitled “Architecture to Use GPIO output Object Distance for 3D Camera,” the contents of which are incorporated herein by reference.

### BACKGROUND OF THE INVENTION

1. Field of the Invention

The present invention relates to a controller applied to a three-dimensional (3D) capture device and a 3D image capture device, and particularly to a controller and a 3D image capture device that can reduce operation burden, memory requirements, and power consumption of a host, and make the host not modify an output circuit thereof provided by the prior art.

2. Description of the Prior Art

In the prior art, the controller applied to a three-dimensional (3D) capture device utilizes two images (e.g. a left eye image and a right eye image) received by the controller to generate a depth map corresponding to a 3D image, and transmits color information of the two images and depth information of the depth map to a host, wherein the two images are used for synthesizing the 3D image. Because data amount corresponding to the color information of the two images and the depth information of the depth map is very huge, the controller needs to utilize a Universal Serial Bus (USB) circuit included thereof to output the color information of the two images and the depth information of the depth map to the host, wherein the USB circuit is an output circuit with faster transmission speed and limited bandwidth. Then, the host utilizes a processor to execute heavy operations on the color information of the two images and the depth information of the depth map to calculate a distance between at least one object included in the 3D image and the 3D image capture device.

Because the processor needs to execute heavy operations on the color information of the two images and the depth information of the depth map to calculate the distance between the at least one object and the 3D image capture device, the processor needs powerful operation capability and the host also needs a large-capacity memory. Thus, the host will have disadvantages of heavier operation burden, a requirement of larger memory capacity, larger power consumption (because power consumption of the USB circuit is very large when the USB circuit transmits data), and so on. In addition, because the USB circuit is an output circuit with limited bandwidth, a number of image capture circuits coupled to the controller will also be limited. In addition, because a standard of industry 4.0 is used for integrating corresponding industry technologies provided by the prior art (that is, the standard of industry 4.0 upgrades the corresponding industry technologies provided by the prior art as far as possible), the USB circuit is also not suitable for the standard of industry 4.0 (because many output circuits (e.g. a Universal Asynchronous Receiver/Transmitter (UART), a Serial Communication Port (COM port), a General Purpose Input/Output (GPIO) circuit, or an Inter-Integrated Circuit (I²C)) provided by the prior art have lower transmission speeds than a transmission speed of the USB circuit). Therefore, the controller with the USB circuit is not a good choice to be applied to the 3D image capture device.

### SUMMARY OF THE INVENTION

An embodiment of the present invention provides a controller applied to a three-dimensional (3D) capture device. The controller includes an input circuit, an object distance generator, and an output circuit. The input circuit is used for receiving at least two images, wherein the at least two images are used for synthesizing a 3D image. The object distance generator is coupled to the input circuit for generating a distance between at least one object included in the 3D image and the 3D image capture device according to the at least two images. The output circuit is coupled to the object distance generator for outputting the distance between the at least one object and the 3D image capture device to a host.

Another embodiment of the present invention provides a controller applied to a 3D capture device. The controller includes an object distance generator and an output circuit. The object distance generator is used for generating a distance between at least one object included in a 3D image and the 3D image capture device, wherein the 3D image is synthesized by at least two images. The output circuit is coupled to the object distance generator for outputting the distance between the at least one object and the 3D image capture device to a host, wherein a transmission speed of the output circuit is less than a transmission speed of USB version 1.0.

Another embodiment of the present invention provides a 3D image capture device. The 3D image capture device includes a light source, at least one image capture circuit, an input circuit, an object distance generator, and an output circuit. The light source is used for emitting a predetermined light pattern. The at least one image capture circuit is used for capturing at least one image including the predetermined light pattern, wherein the at least one image is used for synthesizing a 3D image. The input circuit is coupled to the at least one image capture circuit for receiving the at least one image. The object distance generator is coupled to the input circuit for generating a distance between at least one object included in the 3D image and the 3D image capture device according to the at least one image. The output circuit is coupled to the object distance generator for outputting the distance between the at least one object and the 3D image capture device to a host, wherein a transmission speed of the output circuit is less than a transmission speed of USB version 1.0.

The present invention provides a controller applied to a 3D capture device and a 3D image capture device. The controller and the 3D image capture device utilize an object distance generator to calculate a distance between at least one object included in a 3D image and the 3D image capture device, or calculate the distance and information corresponding to the distance according to at least two images, and utilize an output circuit to output the distance, or output the distance and the information corresponding to the distance to a host. Because data amount corresponding to color information of the at least two images and depth information of a depth map of the 3D image is much greater than data amount corresponding to the distance, and also much greater than data amount corresponding to the information of the distance, the output circuit of the controller can be an output circuit with low transmission speed and low bandwidth. That is to say, the host can receive the distance, or the distance and the information corresponding to the distance from the output circuit of the controller without modifying a low transmission speed and low bandwidth input circuit of the host provided by the prior art. Because the host only receives the distance, or the distance and the information corresponding to the distance from the output circuit of the controller, the host does not need a processor with powerful operation capability and a large-capacity memory. Thus, the controller can reduce operation burden, memory requirements, and power consumption of the host. In addition, because the output circuit is an output circuit with low bandwidth, compared to the prior art, a number of image capture circuits coupled to the controller can be more.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a controller applied to a three-dimensional (3D) capture device according to a first embodiment of the present invention.

FIG. 2 is a diagram illustrating a depth map corresponding to the 3D image.

FIG. 3 is a diagram illustrating predetermined points included in the object.

FIG. 4 is a diagram illustrating predetermined blocks included in the object.

FIG. 5 is a diagram illustrating a 3D image capture device according to a second embodiment of the present invention.

FIG. 6 is a diagram illustrating the image including the predetermined light pattern.

### DETAILED DESCRIPTION

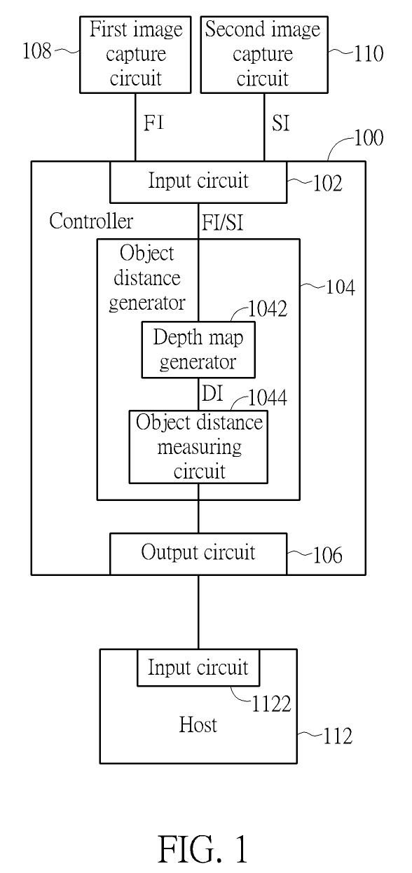

Please refer to FIG. 1. FIG. 1 is a diagram illustrating a controller 100 applied to a three-dimensional (3D) capture device according to a first embodiment of the present invention. As shown in FIG. 1, the controller 100 includes an input circuit 102, an object distance generator 104, and an output circuit 106, wherein the object distance generator 104 includes a depth map generator 1042 and an object distance measuring circuit 1044, the depth map generator 1042 is coupled to the input circuit 102, the object distance measuring circuit 1044 is coupled to the depth map generator 1042, and the output circuit 106 is coupled to the object distance measuring circuit 1044. As shown in FIG. 1, the input circuit 102 can receive a first image FI captured by a first image capture circuit 108 and a second image SI captured by a second image capture circuit 110, wherein the first image FI and the second image SI are used for synthesizing a 3D image. But, the present invention is not limited to the input circuit 102 being only coupled to the first image capture circuit 108 and the second image capture circuit 110. That is to say, the input circuit 102 can be coupled to at least two image capture circuits.

In addition, the object distance generator 104 further includes a synchronization circuit, an image processor, and a calibrator. The synchronization circuit can output a first synchronization signal to the first image FI and a corresponding second synchronization signal to the second image SI (thus, the image processor can process the first image FI and the second image SI together according to the first synchronization signal and the corresponding second synchronization signal), wherein the first image FI is a left eye image, and the second image SI is a right eye image. After the image processor receives the first image FI and the second image SI, the image processor can execute an image processing on the first image FI and the second image SI respectively, wherein the image processing includes at least one of color space conversion, luminance adjustment, resolution adjustment, noise cancellation, edge sharpening, interpolation, and contrast adjustment. In addition, the calibrator can execute a calibration processing on the first image FI and the second image SI respectively, wherein the calibration processing includes at least one of a color space calibration and an assembly calibration. Because the synchronization circuit, the image processor, and the calibrator are obvious to those of ordinary skill in the art, the synchronization circuit, the image processor, and the calibrator are not shown in FIG. 1.

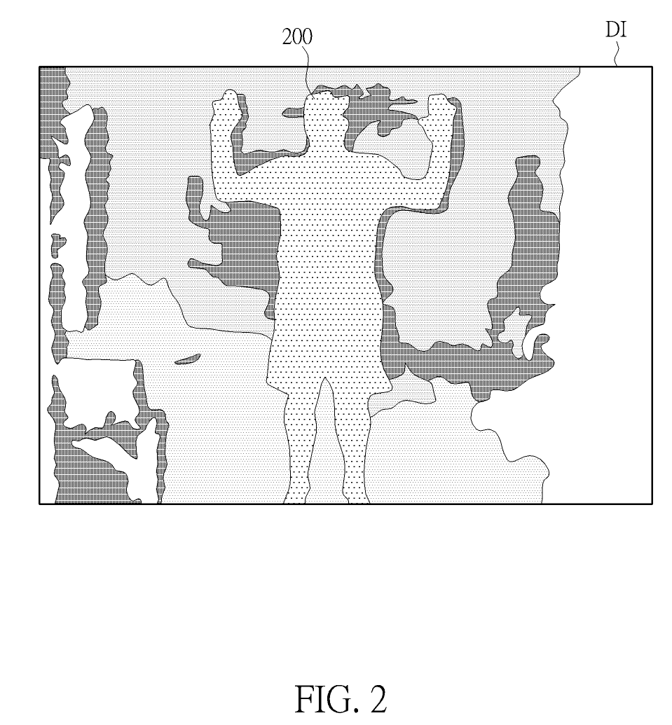

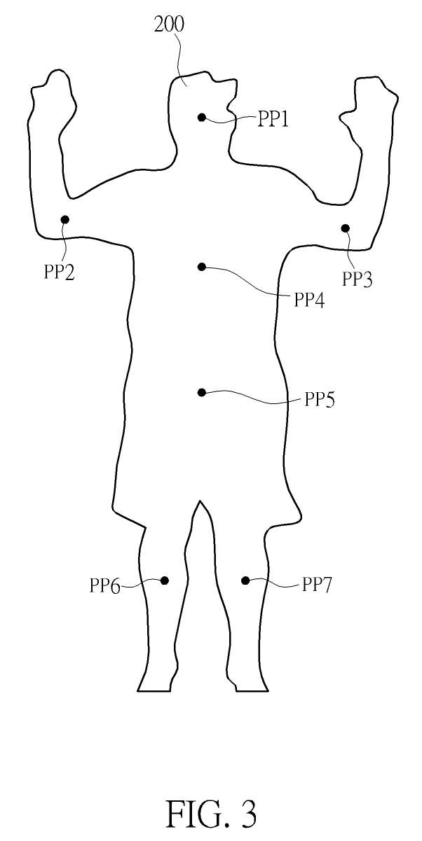

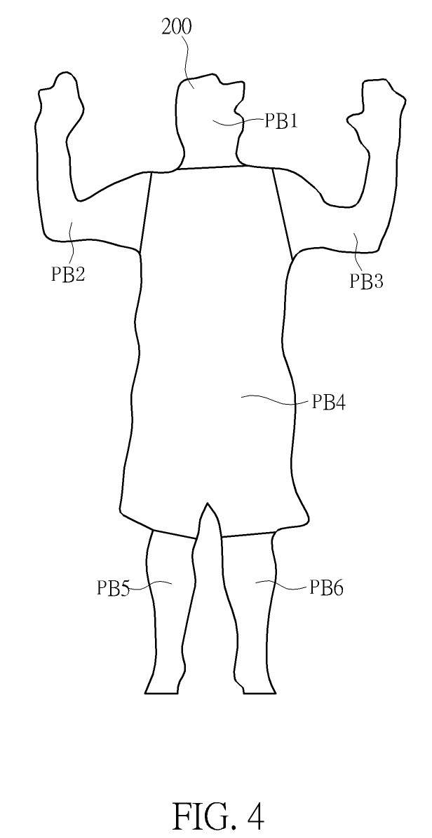

After the image processor executes the image processing on the first image FI and the second image SI, and the calibrator executes the calibration processing on the first image FI and the second image SI, the depth map generator 1042 can generate a depth map DI (as shown in FIG. 2) corresponding to the 3D image according to the first image FI and the second image SI, wherein the depth map DI includes an object 200. But, the present invention is not limited to the depth map DI only including the object 200. After the depth map generator 1042 generates the depth map DI corresponding to the 3D image according to the first image FI and the second image SI, the object distance measuring circuit 1044 can calculate a distance between the object 200 and the 3D image capture device according to the depth map DI, wherein the distance between the object 200 and the 3D image capture device is a distance between at least one predetermined point included in the object 200 and the 3D image capture device. For example, as shown in FIG. 3, the distance between the object 200 and the 3D image capture device is an average distance between predetermined points PP1-PP7 included in the object 200 and the 3D image capture device. In addition, in another embodiment of the present invention, as shown in FIG. 4, the distance between the object 200 and the 3D image capture device is an average distance between predetermined blocks PB1-PPB6 included in the object 200 and the 3D image capture device. In addition, in another embodiment of the present invention, as shown in FIG. 4, the distance between the object 200 and the 3D image capture device is a minimum distance between the predetermined blocks PB1-PB6 included in the object 200 and the 3D image capture device. For example, the distance between the object 200 and the 3D image capture device is a distance between the predetermined block PB1 of the predetermined blocks PB1-PB6 included in the object 200 and the 3D image capture device (that is, the distance between the predetermined block PB1 and the 3D image capture device is the shortest). In addition, in another embodiment of the present invention, when the 3D image capture device is applied to a car and the object 200 is another car, the object distance measuring circuit 1044 not only can calculate the distance between the object 200 and the 3D image capture device (that is, a distance between the car and the another car) according to the depth map DI, but can also generate information corresponding to the distance between the object 200 and the 3D image capture device. For example, when the distance between the object 200 and the 3D image capture device is less than a predetermined distance, the object distance measuring circuit 1044 not only can calculate the distance between the object 200 and the 3D image capture device, but can also generate a warning information to a user owning the car to warn the user that the distance between the object 200 and the 3D image capture device is less than the predetermined distance, so the car may collide with the another car.

After the object distance measuring circuit 1044 calculates the distance between the object 200 and the 3D image capture device, the output circuit 106 can output the distance between the object 200 and the 3D image capture device, or output the distance between the object 200 and the 3D image capture device and the information corresponding to the distance between the object 200 and the 3D image capture device to a host 112 (as shown in FIG. 1), wherein the output circuit 106 can be a Universal Asynchronous Receiver/Transmitter (UART), a Serial Communication Port (COM port), a General Purpose Input/Output (GPIO) circuit, or an Inter-Integrated Circuit (I²C), and a transmission speed of the output circuit 106 is less than a transmission speed (183.1 KB/s) of Universal Serial Bus (USB) version 1.0. For example, the transmission speed of the output circuit 106 is 64 KB/s. But, the present invention is not limited to the transmission speed of the output circuit 106 being 64 KB/s, that is, the output circuit 106 is an output circuit with low transmission speed and bandwidth not limited by USB. In addition, as shown in FIG. 1, the host 112 has an input circuit 1122 corresponding to the output circuit 106.

Because the object distance generator 104 has utilized the depth map generator 1042 and the object distance measuring circuit 1044 to generate the distance between the object 200 and the 3D image capture device, or generate the distance between the object 200 and the 3D image capture device and the information corresponding to the distance between the object 200 and the 3D image capture device through heavy operations, the output circuit 106 does not transmit color information corresponding to the first image FI and the second image SI and depth information of the depth map DI, wherein data amount corresponding to the color information of the first image FI and the second image SI and the depth information of the depth map DI is much greater than data amount corresponding to the distance between the object 200 and the 3D image capture device. Because the data amount corresponding to the color information of the first image FI and the second image SI and the depth information of the depth map DI is much greater than the data amount corresponding to the distance between the object 200 and the 3D image capture device, and also much greater than data amount of the information corresponding to the distance between the object 200 and the 3D image capture device, the output circuit 106 can be an output circuit with low transmission speed and low bandwidth. Therefore, the input circuit 1122 can also be an input circuit with low transmission speed and low bandwidth. That is to say, the host 112 coupled to the controller 100 can receive the distance between the object 200 and the 3D image capture device, or receive the distance between the object 200 and the 3D image capture device and the information corresponding to the distance between the object 200 and the 3D image capture device from the output circuit 106 of the controller 100 without modifying the transmission speed and low bandwidth input circuit 1122 provided by the prior art. Because the host 112 only receives the distance between the object 200 and the 3D image capture device, or receives the distance between the object 200 and the 3D image capture device and the information corresponding to the distance between the object 200 and the 3D image capture device from the output circuit 106 of the controller 100, the host 112 does not need a processor with powerful operation capability and a large-capacity memory. Thus, the controller 100 can reduce operation burden, memory requirements, and power consumption of the host 112. In addition, because the output circuit 106 has low bandwidth, compared to the prior art, a number of image capture circuit coupled to the controller 100 can be more.

In addition, in another embodiment of the present invention, the controller 100, the first image capture circuit 108, and the second image capture circuit 110 can be integrated into the 3D image capture device.

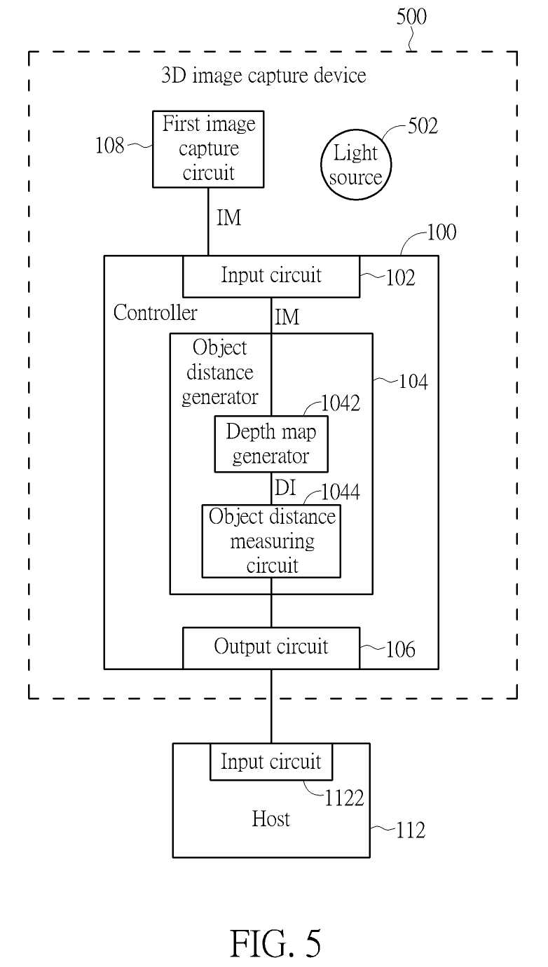

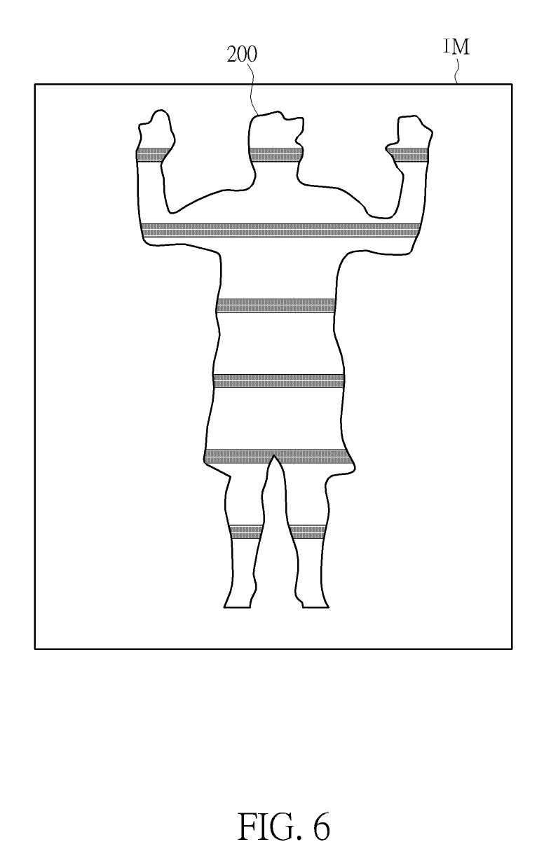

Please refer to FIG. 5. FIG. 5 is a diagram illustrating a 3D image capture device 500 according to a second embodiment of the present invention. As shown in FIG. 5, the 3D image capture device 500 includes the controller 100, the first image capture circuit 108, and a light source 502, wherein the light source 502 is used for emitting a predetermined light pattern, and the predetermined light pattern is a striped light pattern. But, the present invention is not limited to the predetermined light pattern being a striped light pattern. As shown in FIG. 5, the first image capture circuit 108 is used for capturing an image IM (as shown in FIG. 6) including the predetermined light pattern, wherein the image IM including the predetermined light pattern is used for synthesizing a 3D image. Because the first image capture circuit 108 captures the image IM including the predetermined light pattern, the input circuit 102 can receive the image IM and transmit the image IM to the object distance generator 104. In addition, because the image IM includes the predetermined light pattern, the depth map generator 1042 can generate the depth map DI corresponding to the 3D image (as shown in FIG. 2) according to the image IM, and the object distance measuring circuit 1044 can calculate a distance between the object 200 and the 3D image capture device 500 according to the depth map DI. In addition, subsequent operational principles of the object distance generator 104 and operational principles of the output circuit 106 can be referred to the above mentioned corresponding descriptions in FIGS. 1-4, so further description thereof is omitted for simplicity.

To sum up, the controller and the 3D image capture device utilize the object distance generator to calculate a distance between at least one object included in a 3D image and the 3D image capture devices, or calculate the distance and information corresponding to the distance according to at least two image, and utilize the output circuit to output the distance, or output the distance and the information corresponding to the distance to the host. Because data amount corresponding to color information of the at least two images and depth information of a depth map of the 3D image is much greater than data amount corresponding to the distance, and also much greater than data amount corresponding to the information of the distance, the output circuit of the controller can be an output circuit with low transmission speed and low bandwidth. That is to say, the host can receive the distance, or the distance and the information corresponding to the distance from the output circuit of the controller without modifying the low transmission speed and low bandwidth input circuit of the host provided by the prior art. Because the host only receives the distance, or the distance and the information corresponding to the distance from the output circuit of the controller, the host does not need the processor with powerful operation capability and the large-capacity memory. Thus, the controller can reduce operation burden, memory requirements, and power consumption of the host. In addition, because the output circuit is an output circuit with low bandwidth, compared to the prior art, a number of image capture circuits coupled to the controller can be more.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A controller applied to a three-dimensional (3D) capture device, comprising:
an input circuit receiving at least two images, wherein the at least two images are used for synthesizing a 3D image;
an object distance generator coupled to the input circuit for generating a distance between at least one object comprised in the 3D image and the 3D image capture device; and
an output circuit coupled to the object distance generator for outputting the distance between the at least one object and the 3D image capture device to a host.

2. The controller of claim 1, wherein the object distance generator comprises:
a depth map generator coupled to the input circuit for generating a depth map corresponding to the 3D image according to the at least two images; and
an object distance measuring circuit coupled to the depth map generator for generating the distance between the at least one object and the 3D image capture device according to the depth map.

3. The controller of claim 1, wherein the at least two images are generated by at least two image capture circuits.

4. The controller of claim 1, wherein a transmission speed of the output circuit is less than a transmission speed of Universal Serial Bus (USB) version 1.0.

5. The controller of claim 1, wherein the output circuit is a Universal Asynchronous Receiver/Transmitter (UART).

6. The controller of claim 1, wherein the output circuit is a Serial Communication Port (COM port).

7. The controller of claim 1, wherein the output circuit is a General Purpose Input/Output (GPIO) circuit.

8. The controller of claim 1, wherein the output circuit is an Inter-Integrated Circuit (I²C).

9. The controller of claim 1, wherein the distance between the at least one object and the 3D image capture device is a distance between at least one predetermined point comprised in each object of the at least one object and the 3D image capture device.

10. The controller of claim 1, wherein the distance between the at least one object and the 3D image capture device is an average distance between at least one predetermined block comprised in each object of the at least one object and the 3D image capture device.

11. The controller of claim 1, wherein the distance between the at least one object and the 3D image capture device is a minimum distance between at least one predetermined block comprised in each object of the at least one object and the 3D image capture device.

12. A controller applied to a 3D capture device, comprising:
an object distance generator generating a distance between at least one object comprised in a 3D image and the 3D image capture device, wherein the 3D image is synthesized by at least two images; and
an output circuit coupled to the object distance generator for outputting the distance between the at least one object and the 3D image capture device to a host, wherein a transmission speed of the output circuit is less than a transmission speed of USB version 1.0.

13. A 3D image capture device, comprising:
a light source emitting a predetermined light pattern;
at least one image capture circuit capturing at least one image comprising the predetermined light pattern, wherein the at least one image is used for synthesizing a 3D image;
an input circuit coupled to the at least one image capture circuit for receiving the at least one image;
an object distance generator coupled to the input circuit for generating a distance between at least one object comprised in the 3D image and the 3D image capture device according to the at least one image; and
an output circuit coupled to the object distance generator for outputting the distance between the at least one object and the 3D image capture device to a host, wherein a transmission speed of the output circuit is less than a transmission speed of USB version 1.0.
